(19) United States
(12) Patent Application Publication
(10) Pub. No.: US 2008/0182500 A1
(43) Pub. Date: Jul. 31, 2008

(54) Regulating Device For at Least Three Flaps of a Motor Vehicle Ventilation, Heating or Air-Conditioning System

(76) Inventors: Jean-Luc Jessen, Berrwiller (FR); Eric Ludmann, Holtzwihr (FR)

Correspondence Address: FOLEY AND LARDNER LLP;SUITE 500, 3000 K STREET NW, WASHINGTON, DC, 20007, US

(21) Appl. No.: 11/913,242

(22) PCT Filed: May 2, 2006
(86) PCT No.: PCT/EP06/04077

§ 371 Date: Jan. 3, 2008

(30) Foreign Application Priority Data
May 3, 2005 (EP) 05290970.2

(51) Int. Cl. B60H 1/34

(52) U.S. Cl. 454/155

(57) ABSTRACT

The invention relates to a regulating device (15) for at least three flaps (11, 12, 13, 14) of a motor vehicle ventilation, heating or airconditioning system provided with at least one cam plate (16) comprising lever guides (17), wherein another guide (23) is integrated into or on the flap (12).

The invention relates to an actuator for at least three flaps of a ventilation, heating or air conditioning system of a motor vehicle as claimed in the preamble of claim 1.

DE 199 28 834 A1 discloses an actuator of the generic type. In this context, at least three flaps are controlled with a cam plate which has at least two guides which each form a control cam, for guiding activation levers for the flaps, wherein the activation levers are guided in the respective guide by means of guide pins. In order to be able to actuate a plurality of flaps independently, with the control cams being arranged on one side of the cam plate and intersecting, one of the levers is guided via a second guide pin which only comes into use there in an auxiliary guide.

DE 39 10 489 A1 discloses a method for controlling fresh air and a device which is suitable for it. In this context, a guide plate is provided which can be rotated by an air distribution adjustment element (rotary knob) and which has at least two enclosed guide tracks with guide levers guided in them and a total of three articulated levers which are coupled thereto via three elongated hole guides, the first articulated lever of which is connected to a first air flap and an additional air flap, and the second articulated lever and the third articulated lever of which are connected to a third air flap so as to be dependent in terms of rotary adjustment.

However, such actuators are not entirely satisfactory, in particular if more than three flaps have to be controlled with one actuator element.

The object of the invention is to make available an improved actuator, and the actuator is to be as compact as possible.

This object is achieved by means of an actuator having the features of claim 1. Advantageous refinements are the subject matter of the subclaims.

According to the invention, an actuator for at least three flaps of a ventilation, heating or air conditioning system of a motor vehicle, having at least one cam plate which has guides for levers, wherein a further guide is embodied so as to be integrated into or onto one of the flaps. By the provision of a guide which is embodied separately from the cam plate, connection of the movements of individual flaps is made possible, for example the front and rear ventilation flaps, wherein the flaps do not have to be opened and closed in parallel with one another but rather can be carried out in accordance with a positive guide means which is formed by the guide and, for example, a pin which engages in the guide and is embodied on a lever.

In this way it is possible, for example, to enable four flaps to be activated using one actuator element, with the individual flaps pivoting in predefined relations with respect to one another.

The guide is preferably embodied so as to be provided on one of the faces of the flap, in particular the front ventilation flap, or so as to protrude, wherein the guide is arranged in a plane which extends perpendicularly to the pivot axis of the flap. Such a flap is relatively easy and inexpensive to manufacture. In addition, the cam plate is simplified by reducing the guides which are to be provided herein so that, for example, guides have to be provided on just one side of the cam plate. This permits, inter alia, the installation space to be made smaller.

A lever arm with pins is preferably embodied so as to be integrated into one of the flaps, in particular on the ventilation flap for the rear part of the vehicle, or is provided thereon. Such an embodiment is relatively easy and inexpensive to manufacture. In the case of a two-zone air conditioning system, the ventilation flap for the rear part of the vehicle can, for example, also be embodied so as to be continuous for both air conditioning zones so that preferably it is connected to the ventilation flap for the front part of the zone which is assigned to the driver's side.

The lever arm with pin is preferably provided or embodied on a flap which is arranged adjacent to the flap with guide so that only short distances have to be spanned.

The lever arm is preferably arranged in a plane which extends perpendicularly to the pivot axis of the flap, with the two planes in which the lever arm and the guide are arranged extending in parallel.

The guide is preferably embodied in a rounded V or L shape so that delayed opening of the connected flap occurs, but other cam profiles are also possible.

The region of the flap in which the guide is embodied is preferably embodied in one piece with the flap, in particular by means of injection molding.

A stepping motor which turns the cam plate is preferably provided as a common actuator element for the flaps which are connected to one another.

The invention will be explained in detail below by means of an exemplary embodiment and with reference to the drawing, in which:

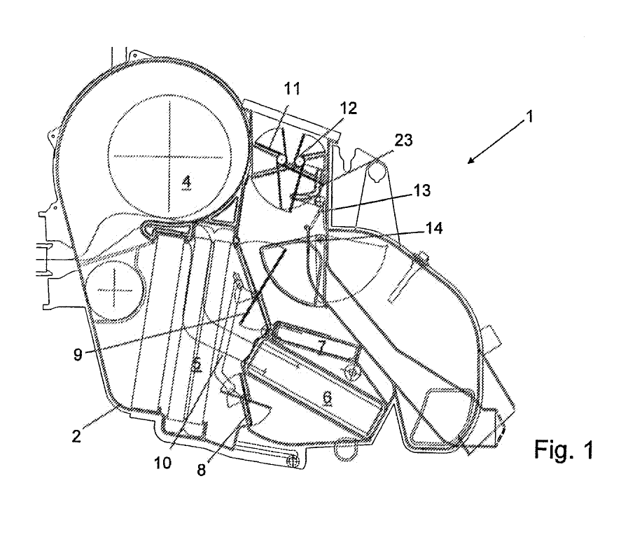

FIG. 1 shows a schematic section through a motor vehicle air conditioning system with a multiplicity of flaps,

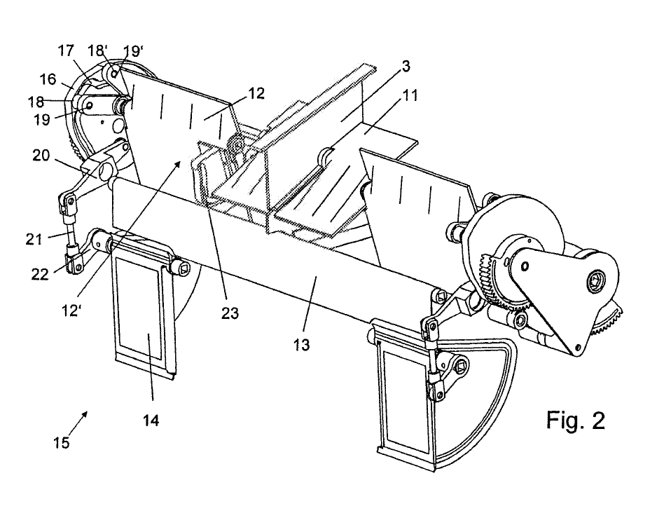

FIG. 2 is a perspective view of the flaps of a two-zone air conditioning system, which flaps are controlled using two actuator elements,

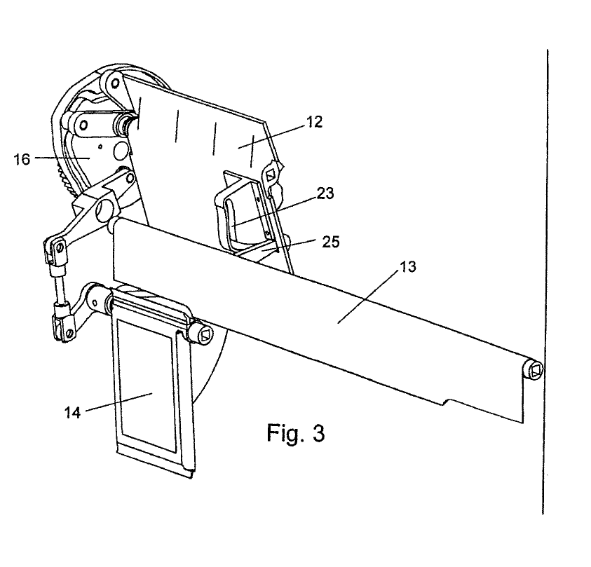

FIG. 3 is a perspective view of a detail of the left-hand region of FIG. 2 without a de-icing flap,

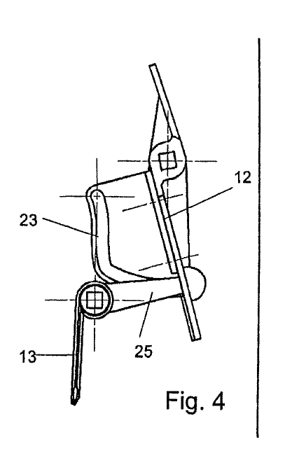

FIG. 4 shows a side view of FIG. 3,

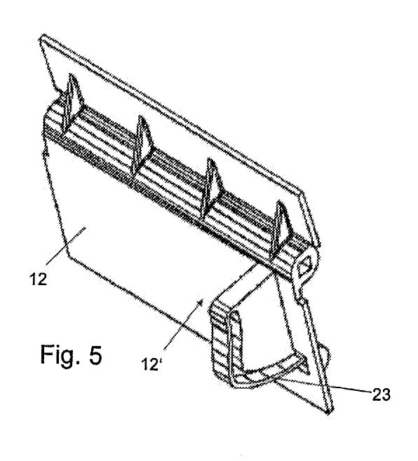

FIG. 5 shows a perspective view of the ventilation flap for the front part of the vehicle with an integrated cam plate,

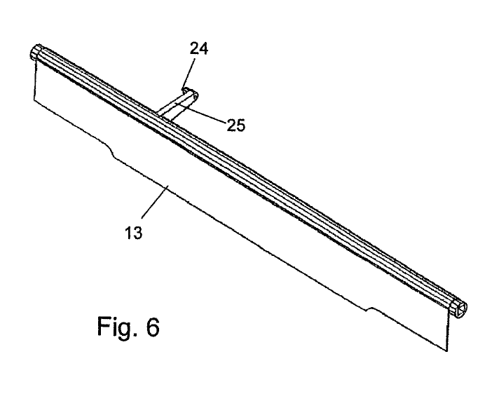

FIG. 6 shows a perspective view of the ventilation flap for the rear part of the vehicle with an integrated lever,

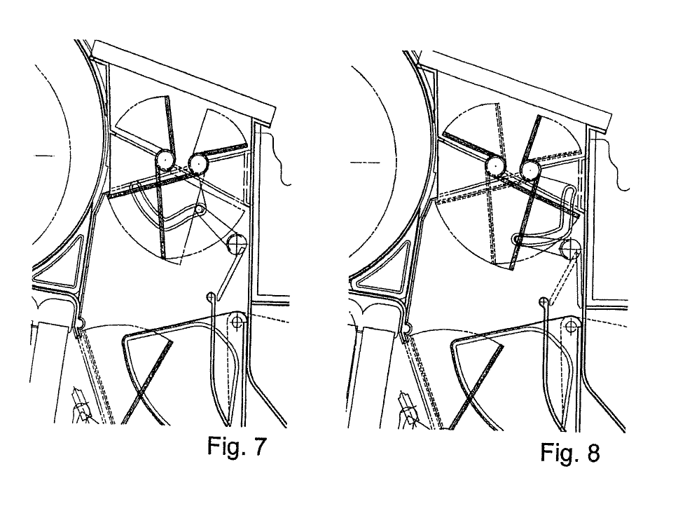

FIG. 7 shows a side view of the flaps in the air conditioning system in the “de-icing” operating state,

FIG. 8 shows a side view of the flaps in the air conditioning system in the “ventilation” operating state,

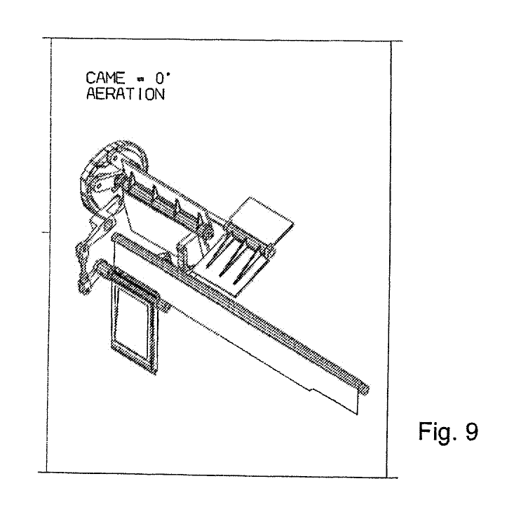

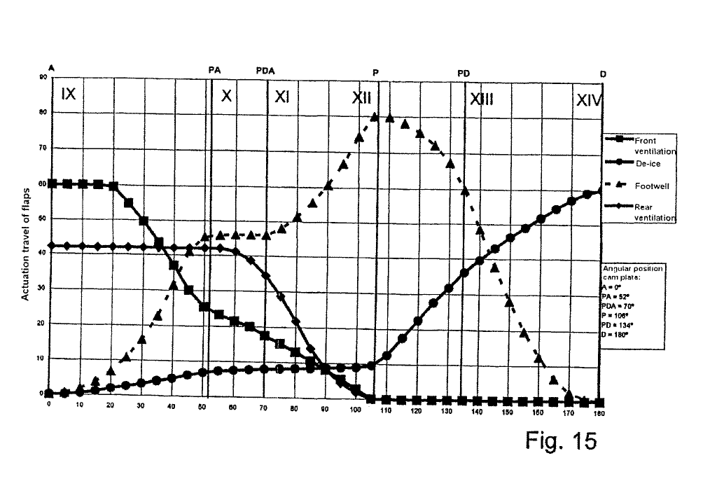

FIG. 9 shows an assembly illustration of the actuator with flaps in the “ventilation” position, which corresponds to the angular position IX in FIG. 15,

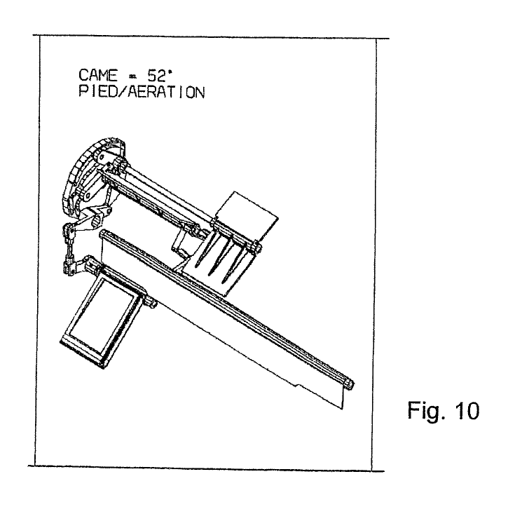

FIG. 10 shows an assembly illustration of the actuator with flaps in the “footwell/ventilation” position, which corresponds to the angular position x in FIG. 15,

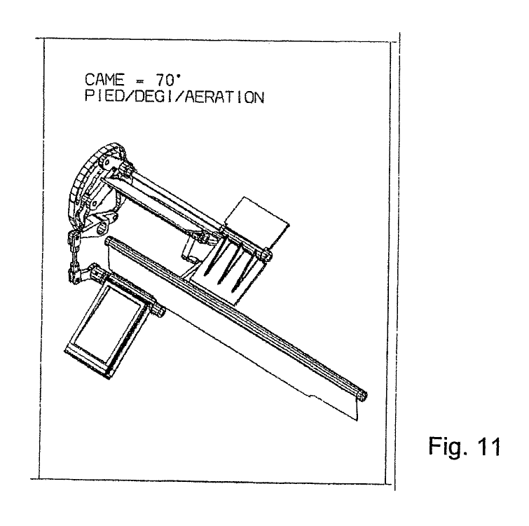

FIG. 11 shows an assembly illustration of the actuator with flaps in the “footwell/ventilation/de-ice” position, which corresponds to the angular position XI in FIG. 15,

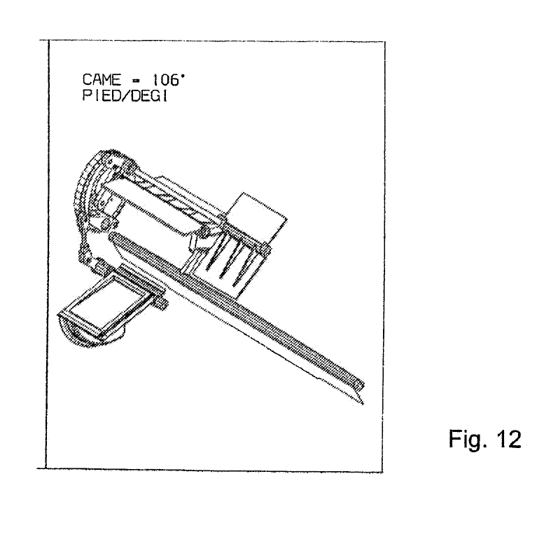

FIG. 12 shows an assembly illustration of the actuator with flaps in the “footwell” position, which corresponds to the angular position XII in FIG. 15,

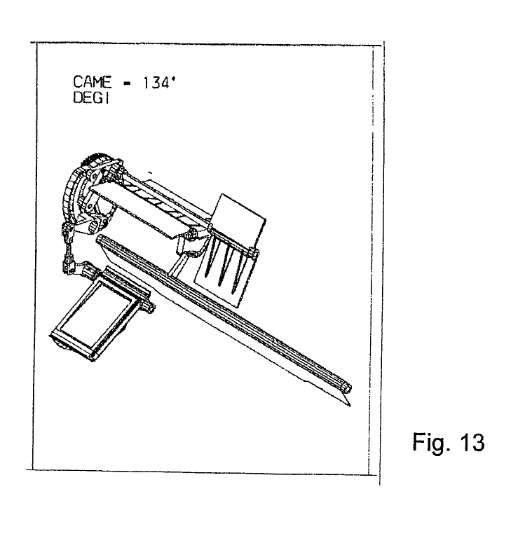

FIG. 13 shows an assembly illustration of the actuator with flaps in a further position “footwell/de-ice”, which corresponds to the angular position XIII in FIG. 15,

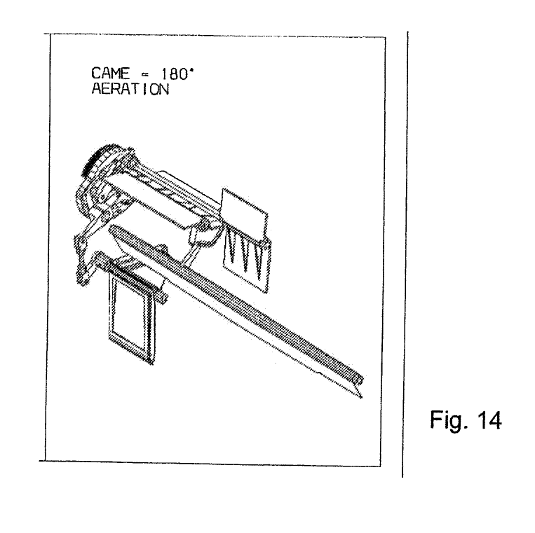

FIG. 14 shows an assembly illustration of the actuator with flaps in the “de-ice” position which corresponds to the angular position XIV in FIG. 15, and

FIG. 15 is a circuit diagram of the actuation of the four flaps.

A motor vehicle air conditioning system 1 has a blower 4, a vaporizer 5 and a heater 6 with additional heater 7 in an air guiding housing 2 with dividing walls 3 for dividing the temperature-controlled air into two air conditioning zones here. The temperature control of the air is carried out in principle in a known fashion using flaps 8 and 9 which guide the airstream through the vaporizer 5 and through the heater 6 with additional heater 7 or past the latter in accordance with the desired temperature, wherein the flaps 8 and 9 are connected to one another in a known fashion by means of a lever 10, and are activated by means of a single actuator element (not illustrated).

For the distribution of the temperature-controlled air four flaps 11, 12, 13 and 14 are provided on a climatic-zone-specific basis for closing off and entirely or partially clearing the corresponding air ducts, which can be activated by means of a common actuator element (not illustrated but a conventional stepping motor here) by means of a corresponding actuator 15. In the text which follows, the reference symbol 11 designates the de-icing flap, the reference number 12 designates the ventilation flap for the front part of the vehicle, the reference number 13 designates the ventilation flap for the rear part of the vehicle, and the reference number 14 designates the footwell flap.

The actuator 15 has a cam plate 16 with a first guide 17 which is embodied in the form of a cam track on the flap side, in which cam track two guide pins 18, 18′, which are arranged on the lever arms 19, 19′ which correspond at the end, are guided. Here, the first lever arm 19 is connected to the ventilation flap 12 for the front part of the vehicle, and the second lever arm 19′ is connected to the de-icing flap 11 (cf. FIG. 2), which are pivotably mounted.

In addition, a third lever arm 20 which is pivotably mounted is guided with one of its ends in a further guide in the form of a further cam track on the same side of the cam plate 16, said lever arm 20 adjusting the foot flap 14 by means of a pivoting movement. For this purpose, at the end of the third lever arm 20 lying opposite the cam plate 16 an intermediate element 21 is pivotably attached by one end and is pivotably attached by the other end to a fourth lever arm 22 which is connected to the pivotably mounted foot flap 14 so that by means of a pivoting movement of the third lever arm 20 owing to a rotation of the cam plate 16, which brings about a downward pivoting movement of the lever arm 20 in FIG. 3, the lower edge of the foot flap 14 is moved counter to the viewing direction in FIG. 3 (cf. for example FIGS. 9 and 10).

At the pivotably mounted ventilation flap 12 for the front part of the vehicle, a type of cam plate is embodied so as to extend in a radial plane on a flap face 12′ (cf. FIG. 5), which cam plate forms a rounded, approximately L-shaped guide 23 for a pin 24 which is provided at the end of a lever arm 25. The lever arm 25 is embodied so as to be integrated into the ventilation flap 13 for the rear part of the vehicle (cf. FIG. 6), and it is also embodied so as to extend in a radial plane.

As a result of the interaction of the guide 23 and pin 24, the ventilation flap 13 for the rear part of the vehicle is activated as a function of the ventilation flap 12 for the front part of the vehicle, and, as is apparent from FIG. 15, in the case of closing of the ventilation flap 13 for the front part of the vehicle the ventilation flap 14 for the rear part of the vehicle is only closed after a delay, but both flaps are closed completely at approximately the same time. Correspondingly, the ventilation flap 14 for the rear part of the vehicle completely opens first, before the ventilation flap 13 for the front part of the vehicle opens completely. The angular positions of the cam plate which are represented by perpendicular, bold continuous lines in FIG. 15 and are designated by IX to XIV are illustrated in FIGS. 9 to 14.

1. An actuator for at least three flaps of a ventilation, heating or air conditioning system of a motor vehicle, having at least one cam plate which has guides for levers, wherein a further guide is embodied so as to be integrated into or onto one of the flaps.

2. The actuator as claimed in claim 1, wherein the guide is embodied so as to be provided on one of the faces of the flap or so as to protrude, wherein the guide is arranged in a plane which extends perpendicularly to the pivot axis of the flap.

3. The actuator as claimed in claim 1 wherein a lever arm with pins is embodied so as to be integrated into one of the flaps or is provided thereon.

4. The actuator as claimed in claim 3, wherein the lever arm with pins is provided or embodied on a flap which is arranged adjacent to the flap with guide.

5. The actuator as claimed in claim 3, wherein the lever arm is arranged in a plane which extends perpendicularly to the pivot axis of the flap.

6. The actuator as claimed in claim 1, wherein the guide is embodied in a rounded V or L shape.

7. The actuator as claimed in claim 1, wherein the region of the flap in which the guide is embodied is embodied in one piece with the flap.

8. The actuator as claimed in claim 1, wherein the pivot axes of the flaps are arranged parallel to one another.

9. The actuator as claimed in claim 1, wherein precisely one actuator element is provided.

10. The actuator as claimed in claim 9, wherein the actuator element is a stepping motor.

11. The actuator as claimed in claim 1, wherein the flaps are plastic injection-molded parts.
